(19) United States
(12) Patent Application Publication
(10) Pub. No.: US 2026/0105076 A1
(43) Pub. Date: Apr. 16, 2026

(54) LEVERAGING LARGE LANGUAGE MODELS (LLMS) FOR SEMANTICALLY CHUNKING CONTENT

(71) Applicant: View Systems, Inc., Dover, DE (US)

(72) Inventors: Joel Christner, El Dorado Hills, CA (US); Blake Martz, San Diego, CA (US); Yipeng Li, Campbell, CA (US)

(21) Appl. No.: 19/350,480

(22) Filed: Oct. 6, 2025

Related U.S. Application Data
(60) Provisional application No. 63/706,565, filed on Oct. 11, 2024.

(51) Int. Cl. G06F 16/332; G06F 16/31

(52) U.S. Cl. CPC G06F 16/3326; G06F 16/316

(57) ABSTRACT

This disclosure provides methods, devices, and systems for generating vector embeddings. The present implementations more specifically relate to techniques for segmenting data along semantic boundaries to be mapped to vector embeddings. In some aspects, a data orchestration system may determine one or more semantic boundaries associated with a data asset based on a neural network model and segment the data asset into chunks based at least in part on the one or more semantic boundaries. The data orchestration system further maps each chunk to a respective vector embedding associated with the neural network model.

### CROSS-REFERENCE TO RELATED APPLICATIONS

This application claims priority and benefit under 35 U.S.C. § 119(e) to U.S. Provisional Patent Application No. 63/706,565, filed October 11, 2024, which is incorporated herein by reference in its entirety.

### TECHNICAL FIELD

This disclosure relates generally to machine learning, and specifically to leveraging large language models (LLMs) for semantically chunking content.

### DESCRIPTION OF RELATED ART

Machine learning (also referred to as “artificial intelligence” or “AI”) is a technique for improving the ability of a computer system or application to perform a certain task. Machine learning can be generally broken down into two component parts: training and inferencing. During the training phase, a machine learning system is provided with one or more “answers” and a large volume of raw training data associated with the answers. The machine learning system analyzes the training data to learn a set of rules (also referred to as a machine learning “model”) that can be used to describe each of the answers. During the inference phase, the machine learning system may infer answers from new data using the learned set of rules.

Deep learning is a particular form of machine learning in which the inferencing and training phases are performed over multiple layers. Deep learning architectures are often referred to as “artificial neural networks” due to the manner in which information is processed (similar to a biological nervous system). For example, each layer of an artificial neural network may be composed of one or more “neurons.” Each layer of neurons may perform a different transformation on the output data from a preceding layer so that the final output of the neural network results in the desired inferences. The set of transformations associated with the various layers of the network is referred to as a “neural network model.”

Some neural networks are designed to process vectorized data, also referred to as “embeddings.” An embedding is a numerical vector, in any high-dimensional space, having a magnitude and direction that represents a real-world object (such as a word) or set of objects (such as a sentence, paragraph, or other grouping of words). The dimensionality of the vector space is defined by the neural network model used to process the embeddings. However, objects of various sizes (such as words, sentences, and/or paragraphs) can be mapped to individual embeddings in the same vector space. In other words, same-size embeddings may represent different amounts of information for a given AI application. Thus, there is a need to balance fidelity and accuracy when mapping objects to embeddings in a predefined vector space.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for generating embeddings. The method includes steps of determining one or more semantic boundaries associated with a data asset based on a neural network model; segmenting the data asset into a plurality of chunks based at least in part on the one or more semantic boundaries; and mapping the plurality of chunks to a plurality of vector embeddings, respectively, associated with the neural network model.

Another innovative aspect of the subject matter of this disclosure can be implemented in a data orchestration system, including a processing system and a memory. The memory stores instructions that, when executed by the processing system, cause the data orchestration system to determine one or more semantic boundaries associated with a data asset based on a neural network model; segment the data asset into a plurality of chunks based at least in part on the one or more semantic boundaries; and map the plurality of chunks to a plurality of vector embeddings, respectively, associated with the neural network model.

### BRIEF DESCRIPTION OF THE DRAWINGS

The present implementations are illustrated by way of example and are not intended to be limited by the figures of the accompanying drawings.

FIG. 1 shows a block diagram of an example data orchestration system, according to some implementations.

FIG. 2 shows a block diagram of an example data processing pipeline, according to some implementations.

FIG. 3 shows a block diagram of an example data segmentation system, according to some implementations.

FIG. 4 shows a block diagram of an example retrieval augmented generation (RAG) system, according to some implementations.

FIG. 5 shows another block diagram of an example data orchestration system, according to some implementations.

FIG. 6 shows an illustrative flowchart depicting an example operation for generating embeddings, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems or devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described herein. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, or executed by a computer or other processor.

The various illustrative logical blocks, modules, circuits and instructions described in connection with the implementations disclosed herein may be executed by one or more processors (or a processing system). The term “processor,” as used herein may refer to any general-purpose processor, special-purpose processor, conventional processor, controller, microcontroller, or state machine capable of executing scripts or instructions of one or more software programs stored in memory.

A data asset (which may be a document, spreadsheet, slideshow, table, or image, among other examples) can be subdivided into multiple segments that are mapped to respective embeddings for processing by an AI application. For example, a data segment can be a single word or a string of words (such as a sentence, paragraph, or page of text) in the underlying data asset. The granularity of the mapping (such as the number of words mapped to each embedding) affects the accuracy and fidelity of the embeddings. For example, a one-to-one mapping (where each embedding represents exactly one word) may improve the accuracy of search results for specific words at the cost of contextual information (since the surrounding “context” for each word is lost). However, because a vector space has a fixed number of dimensions (which limits the number of unique vector representations available for embeddings), mapping too many words to a single embedding may degrade the fidelity of the embedding.

Aspects of the present disclosure recognize that some neural network models, such as natural language processing (NLP) models or large language models (LLMs), are trained to infer semantic meaning from textual content, which can provide a basis for segmenting a data asset along contextual lines (such as in a way that preserves the context of each data segment). Aspects of the present disclosure further recognize than an LLM also can be instructed (such as through prompt engineering) to partition a data asset into any number of segments based on the meanings (or “learnings”) inferred from the text. Thus, by leveraging neural networks to infer the data segments, aspects of the present disclosure can partition a data asset along semantically related boundaries in a way that balances the size of each data segment with the dimensionality of the vector space to achieve high fidelity and accuracy in the resulting embeddings.

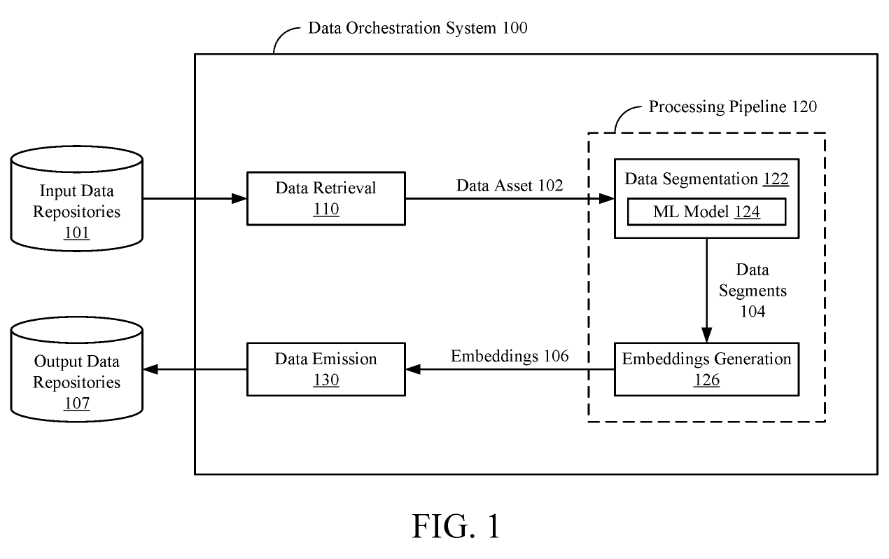

FIG. 1 shows a block diagram of an example data orchestration system 100, according to some implementations. The data orchestration system 100 is configured to retrieve data assets 102 from one or more input data repositories 101, convert each data asset 102 to a respective set of embeddings 106, and emit the resulting embeddings 106 to one or more output data repositories 107. A data asset 102 can be a document, file, or database of any type (such as images, videos, slideshow presentations, word processing documents, SQL databases, JavaScript Object Notation (JSON) files, and HyperText Markup Language (HTML) documents, among other examples). In some implementations, the output data repositories 107 may be different than the input data repositories 101. In some other implementations, the output data repositories 107 may be the same as the input data repositories 101.

The data orchestration system 100 includes a data retrieval component 110, a data processing pipeline 120, and a data emission component 130. The data retrieval component 110 is configured to communicate or interface with the input data repositories 101 to facilitate the retrieval of data assets 102. Example suitable input data repositories 101 include computers, servers, storage systems, and third-party platforms (such as software-as-a-service (SaaS) platforms), among other examples. In some implementations, the data retrieval component 110 may store information identifying one or more input data repositories 101 from which the data assets 102 can be retrieved. In some implementations, the data retrieval component 110 may detect or identify the input data repositories 101 using network discovery tools (such as by querying Active Directory or performing port scans on the network).

The data processing pipeline 120 is configured to perform a number of data operations that transform the data asset 102 into the embeddings 106. More specifically, the data processing pipeline 120 may process the data asset 102 according to one or more data objectives and/or requirements of a processing system or application (such as a machine learning model) intended to consume the data asset 102. In some implementations, the data processing pipeline 120 may store a set of discrete data operations that can be used to construct a data flow. A data flow defines the order in which the data operations are performed, including which specific steps are taken given a successful step, a failed step, or a step that encounters an unrecoverable exception. The data operations may include open-source and/or closed-source libraries that are configured to perform discrete tasks against the data. Example suitable tasks include loading data from a file or database, extracting text, stemming or lemmatizing the text, obfuscation and redaction, and merging it with other data, among other examples.

In the example of FIG. 1, the data processing pipeline 120 is shown to include at least a data segmentation component 122 and an embeddings generation component 126. The data segmentation component 122 is configured to subdivide the data asset 102 into one or more data segments 104 to be mapped to respective embeddings 106. In some aspects, the data segmentation component 122 may balance the granularity of the data segments 104 with the resource limitations of the data processing pipeline 120 and/or with the data objectives or requirements of the processing system or application intended to consume the data asset 102. For example, a one-to-one mapping of words to embeddings 106 may improve the precision of search results for specific words at the cost of contextual information. However, because a vector space has a fixed number of dimensions, mapping too many words to a single embedding also may degrade the fidelity of such embeddings.

In some implementations, the data segmentation component 122 may infer the data segments 104 based on a machine learning (ML) model 124 that is trained to infer semantic meaning from user queries (also referred to as “prompts”) and generate responses to such queries (also referred to as “completions”) using natural language which conveys understanding of the semantic meaning. Example suitable ML models include NLP models and LLMs, among other examples. For example, the data segmentation component 122 may leverage the semantic understanding of the ML model 124 to partition the data asset 102 along semantically related boundaries (also referred to as “semantic boundaries”) and to ensure that each data segment 104 is aligned with one or more of the semantic boundaries. More specifically, the data segmentation component 122 may balance the size of each data segment 104 with the dimensionality of the vector space to achieve high fidelity in the resulting embeddings while preserving the contextual information contained therein.

The embeddings generation component 126 is configured to generate the embeddings 106 based on the data segments 104. As described above, an embedding is a mapping of any discrete (or categorical) variable to a vector of continuous numbers (such as a floating-point number) in a high-dimensional space. The mapping between objects and embeddings is defined by the neural network model used to process the embeddings. In other words, different neural network models may map the same object to different vector embeddings (which may reside in different multidimensional spaces). Thus, in some implementations, the embeddings generation component 126 may generate the embeddings 106 based on an associated AI application and/or neural network model (such as an LLM).

The data emission component 130 is configured to communicate or interface with the output data repositories 107 to facilitate the storage or emission of the embeddings 106. Example suitable output data repositories 107 include computers, servers, storage systems, and/or third-party platforms that are connected or otherwise accessible to processing systems and/or applications configured to use or perform additional processing on the embeddings 106 (such as for analytics or machine learning). In some implementations, the data emission component 130 also may emit metadata (not shown for simplicity) to be stored in association with the embeddings 106. For example, the embeddings 106 and the metadata may be stored in a relational database (which may span one or more output data repositories 107) that maps each embedding 106 to its associated metadata.

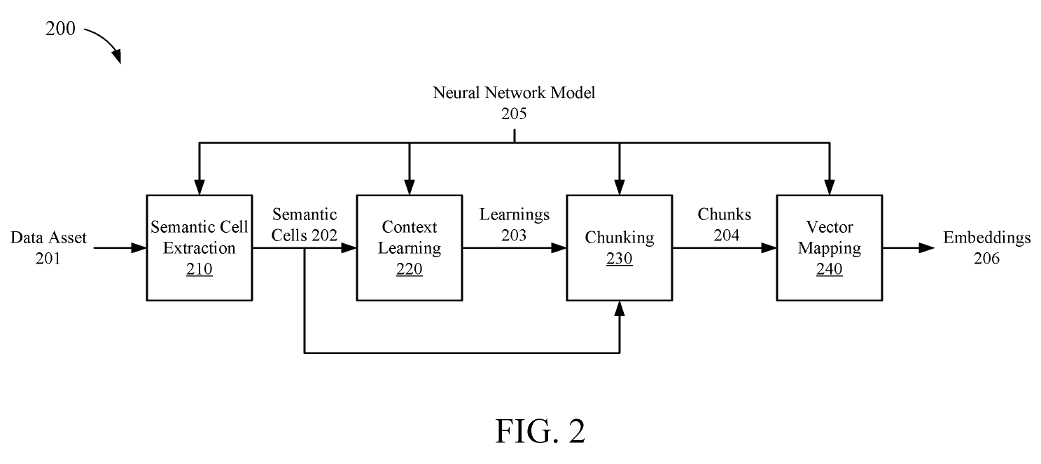

FIG. 2 shows a block diagram of an example data processing pipeline 200, according to some implementations. In some implementations, the data processing pipeline 200 may be one example of the data processing pipeline 120 of FIG. 1. More specifically, the data processing pipeline 200 is configured to transform a data asset 201 into a set of embeddings 206. With reference to FIG. 1, the data asset 201 and embeddings 206 may be examples of the data asset 102 and embeddings 106, respectively. In some implementations, the embeddings 206 may be associated with a neural network model 205. In other words, the data processing pipeline 200 may be configured to prepare the data asset 201 to be processed or consumed by the neural network model 205 or an AI application associated therewith.

Aspects of the present disclosure recognize that neural network models (including natural language processing (NLP) models and large language models (LLMs)) have predefined dimensionalities. In other words, a neural network model can only process and/or generate vector embeddings having a fixed size or dimension. As a result, the amount of input data represented by each vector embedding affects its accuracy and fidelity. For example, mapping too much or too little input data to each vector embedding, given the dimensionality of the vector space, may reduce the accuracy and/or fidelity of the results. Thus, in some aspects, the data processing pipeline 200 may subdivide the data asset 201 into one or more segments (such as the data segments 104 of FIG. 1) based, at least in part, on the dimensionality of the vector space associated with the neural network model 205. In some implementations, the data processing pipeline 200 may balance the size of each data segment with the dimensionality of the vector space to achieve high fidelity and accuracy in the resulting embeddings 206.

The data processing pipeline 200 includes a semantic cell extraction component 210, a context learning component 220, a chunking component 230, and a vector mapping component 240. The semantic cell extraction component 210 is configured to parse the data in the data asset 201 into one or more semantic cells 202. As used herein, the term “semantic cell” refers to a grouping of data that is semantically related. Example suitable semantic cells include sentences, paragraphs, pictures, and/or slides. A semantic cell can also be a “child” of another semantic cell (such as a sentence within a paragraph). Aspects of the present disclosure recognize that some neural network models (such as NLPs and LLMs) are trained to infer semantic meaning from input data, which can be used to delineate content along semantic boundaries (similar to bounding boxes in computer vision). Thus, in some implementations, the semantic cell extraction component 210 may infer the semantic cells 202 based on a neural network model 205. In the example of FIG. 2, the same neural network model 205 is used to infer the semantic cells 202 and generate the embeddings 206. However, in actual implementations, any suitable language model may be used to infer the semantic cells 202 (which may be the same or different than the model used to generate the embeddings 206).

The context learning component 220 is configured to extract one or more learnings 203 from each semantic cell 202. As used herein, a “learning” represents any semantic meaning or contextual information that can be derived from a semantic cell. For example, given a semantic cell 202 that includes the phrase, “the quick brown fox jumps over the lazy dog,” the context learning component 220 may learn that the cell includes a fox and a dog, the fox is quick and brown, the dog is lazy, and the fox jumps over the dog. In some implementations, the context learning component 220 may infer the learnings 203 based on a neural network model 205 (such as an NLP model or LLM). In the example of FIG. 2, the same neural network model 205 is used to infer the learnings 203 and generate the embeddings 206. However, in actual implementations, any suitable language model may be used to infer the learnings 203 (which may be the same or different than the model used to generate the embeddings 206). In some implementations, the context learning component 220 may extract a number of learnings 203 from each semantic cell 202 corresponding to the number of desired embeddings 206 to be mapped to the semantic cell 202.

The chunking component 230 is configured to arrange the data within each semantic cell 202 into even more granular chunks 203. As used herein, the term “chunk” refers to a subgrouping of data that is related to a given semantic cell. For example, chunks may be used to break down a semantic cell into smaller groups of data that can be processed more efficiently by a machine or computer (such as an LLM or NLP model) or yield more accurate and/or precise results. In some implementations, the chunking component 230 may determine the size and content for each chunk 203 based at least in part on the learnings 203. For example, given a semantic cell 202 that includes the phrase, “the quick brown fox jumps over the lazy dog,” and three learnings 203 indicating that the fox is quick and brown, the dog is lazy, and the fox jumps over the dog, the chunking component 230 may parse the semantic cell 202 into three data chunks 204 (corresponding to the three learnings): “the quick brown fox,” “jumps over,” and “the lazy dog.” In some implementations, the chunking component 230 may infer the chunks 204 based on a neural network model 205. In the example of FIG. 2, the same neural network model 205 is used to infer the chunks 204 and generate the embeddings 206. However, in actual implementations, any suitable language model may be used to infer the data chunks 204 (which may be the same or different than the model used to generate the embeddings 206).

The vector mapping component 240 is configured to map each of the data chunks 204 to a respective embedding 206. In some aspects, the vector mapping component 240 may perform the mapping based, at least in part, on the neural network model 205. For example, the data chunks 204 may be passed or otherwise processed through one or more embeddings layers of the neural network model 205 having outputs that result in the embeddings 206. In some implementations, the embeddings 206 may be stored in a vector repository or relational database that also stores the semantic cells 202, the data chunks 203, and/or metadata associated therewith (not shown for simplicity). By leveraging the neural network model 205 (or any other suitable neural network model) to infer the semantic cells 202 and the chunks 204 that are mapped to the embeddings 206, aspects of the present disclosure can partition the data asset 201 along semantically related boundaries in a way that balances the size of each data chunk 204 with the dimensionality of the vector space to achieve high fidelity and accuracy in the resulting embeddings 206.

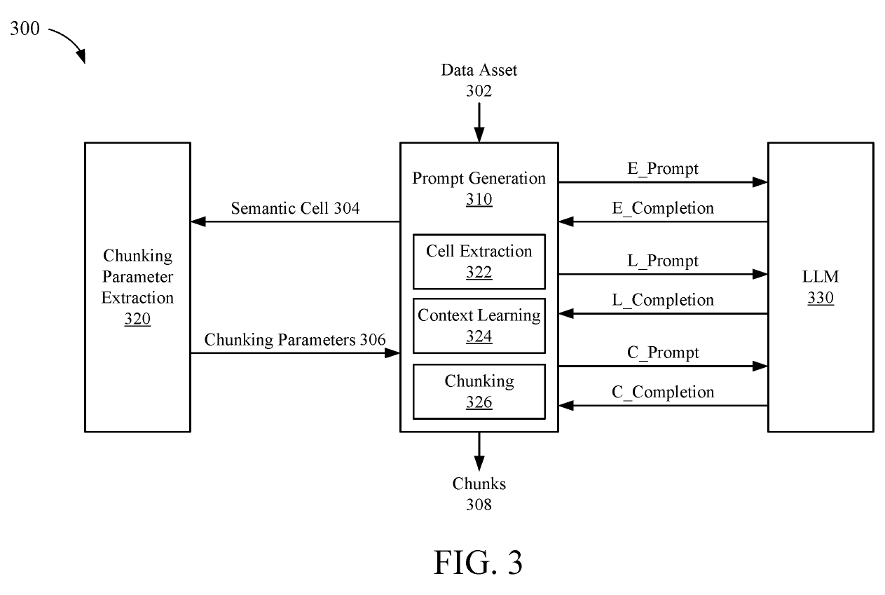

FIG. 3 shows a block diagram of an example data segmentation system 300, according to some implementations. In some implementations, the data segmentation system 300 may be one example of the data segmentation component 122 of FIG. 1. More specifically, the data segmentation system 300 is configured to subdivide a data asset 302 into one or more data chunks 308 to be mapped to respective embeddings (not shown for simplicity). In some implementations, the data asset 302 and data chunks 308 may be examples of a data asset 201 and data chunks 204, respectively, of FIG. 2.

The data segmentation system 300 includes a prompt generation component 310, a chunking parameter extraction component 320, and a large language model (LLM) 330. The prompt generation component 310 is configured to extract a semantic cell 304 from the data asset 302 and arrange the contents of the semantic cell 304 into a number (N) of chunks 308. In some implementations, the prompt generation component 310 may infer the chunks 308 from the semantic cell 304 based on the LLM 330. More specifically, the prompt generation component 310 may query or instruct the LLM (such as through prompt engineering) to parse the semantic cell 304 from the data asset 302 and partition the semantic cell 304 into N chunks 308. For example, the prompt generation component 310 may emit prompts to the LLM 330 carrying the instructions and receive completions from the LLM 330 carrying responses to the instructions. In some implementations, the LLM 330 may be stored and executed locally, for example, as an integrated component of the data segmentation system 300 (or the underlying computing platform or architecture). In some other implementations, the LLM 330 may be hosted remotely, for example, on a server or computing device that is separate from the data segmentation system 300. For example, the prompt generation component 310 may communicate with the LLM 330 via an application programming interface (API).

In some implementations, the prompt generation component 310 may include a cell extraction subcomponent 322, a context learning subcomponent 324, and a chunking subcomponent 326. The cell extraction subcomponent 322 is configured to retrieve, from the LLM 330, a semantic cell 304 associated with the data asset 302. In some implementations, the cell extraction subcomponent 322 may be one example of the semantic cell extraction component 210 of FIG. 2. More specifically, the cell extraction subcomponent 322 may generate an “extraction” prompt (E_Prompt) that includes a request to retrieve a grouping or subset of semantically related content from the data asset 302 (such as a sentence, paragraph, or page). An example E_Prompt may include the language: “Please recite the first paragraph of the source material” (where the semantic cell 304 is defined as a paragraph). The cell extraction subcomponent 322 emits the E_Prompt to the LLM 330 and receives an “extraction” completion (E_Completion) from the LLM 330 that includes the requested paragraph of the data asset 302.

The chunking parameter extraction component 320 is configured to extract one or more chunking parameters 306 from the semantic cell 304. As used herein, a “chunking parameter” may define a number of chunks 308 and/or a size of each chunk 308 to be extracted from the semantic cell 304. As described with reference to FIG. 2, partitioning a semantic cell into chunks that are too big or too small in proportion to the dimensionality of the vector space may reduce the accuracy and/or fidelity of the resulting embeddings. Thus, in some implementations, the chunking parameter extraction component 320 may determine a minimum and/or maximum chunk size suitable for the dimensions of the embeddings and may determine the number of chunks 308 to be extracted from the semantic cell 304 based on the chunk size. Example suitable chunk sizes may include fixed-width (chunks must be less than a threshold number of bytes), variable-width (chunks must be within a minimum and a maximum number of bytes), and sliding window sizes (chunks must have a fixed- or variable-width, where at least a portion of each chunk overlaps with a portion of a neighboring chunk), among other examples.

The context learning subcomponent 324 is configured to retrieve, from the LLM 330, N learnings associated with the semantic cell 304 according to the chunking parameters 306 (where N is the number of chunks indicated by the chunking parameters 306). In some implementations, the context learning subcomponent 324 may be one example of the context learning component 220 of FIG. 2. More specifically, the context learning subcomponent 324 may generate a “learning” prompt (L_Prompt) that includes the semantic cell 304 and a request for N learnings associated therewith. In some implementations, the L_Prompt may further include a request to order the N learnings based on the order in which they are conveyed in the semantic cell 304. An example L_Prompt may include the language: “Please read the following paragraph and evaluate what information it is attempting to convey. I need to break this into five key learnings, and the learnings should be ordered based on the conveyance of the supporting information within the source data” (where the number of chunks is equal to 5). The context learning subcomponent 324 emits the L_Prompt to the LLM 330 and receives a “learning” completion (L_Completion) from the LLM 330 that includes the requested N learnings, in ordered sequence.

The chunking subcomponent 326 is configured to retrieve, from the LLM 330, N chunks 308 associated with the N learnings included in the L_Completion. In some implementations, the chunking subcomponent 326 may be one example of the chunking component 230 of FIG. 2. More specifically, the chunking subcomponent 326 may generate a “chunking” prompt (C_Prompt) that includes a request to partition the semantic cell 304 based on the N learnings associated therewith (and their assigned order). An example C_Prompt may include the language: “Based on the five key learnings you’ve extracted from the source material, and the fact that these five key learnings are ordered based on the position of the supporting data within the source content from which you derived these key learnings, I’d like you to split the original content along boundaries that most adequately reflect the five key learnings, and I’d like you to break the original content into five smaller pieces. Ensure that no piece exceeds 1,024 characters, and that every character and every word from the source content is reflected in at least one of the smaller pieces you emit. The smaller pieces, or chunks, that you emit, must in sum contain the full source data I supplied to you.” (where the number of chunks is equal to 5 and the size of each chunk must be less than 1,024 characters).

In some implementations, the C_Prompt also may include the semantic cell 304 and/or the N learnings included in the L_Completion (such as where the LLM 330 does not have memory to cache the semantic cell or learnings from the previous interaction). The context learning subcomponent 324 emits the C_Prompt to the LLM 330 and receives a “chunking” completion (C_Completion) from the LLM 330 that includes the requested N data chunks 308. By leveraging the semantic understanding and natural language capabilities of an LLM 330 (which may be any existing LLM), the data segmentation system 300 may extract a semantic cell 304 from the data asset 302 and partition the semantic cell 304 into smaller chunks 308 that can be efficiently mapped to respective embeddings while preserving the contextual information within each chunk. Unlike existing algorithmic approaches to data segmentation, the LLM 330 provides a layer of intelligence to the chunking operation that is rooted in semantic reasoning. As a result, the data chunks 308 of the present implementations may yield embeddings with greater accuracy and fidelity compared to data chunks that could otherwise be generated using existing algorithmic approaches to data segmentation.

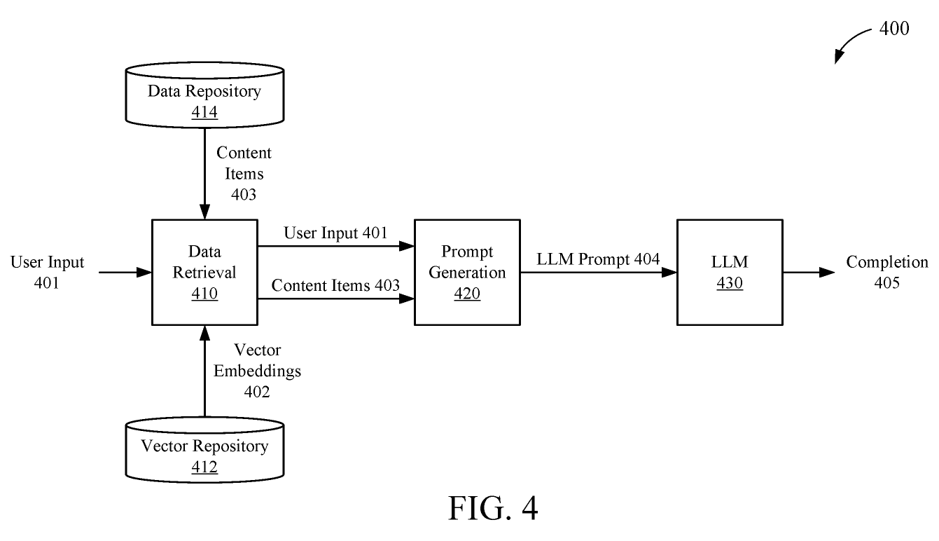

FIG. 4 shows a block diagram of an example RAG system 400, according to some implementations. The RAG system 400 is configured to receive user input 401 and infer a completion 405 for the user input 401 based on an LLM 430. More specifically, the RAG system 400 may retrieve additional contextual information related to the user input 401 and provide such additional context to the LLM 430 for generating the completion 405.

The RAG system 400 includes a data retrieval component 410 and a prompt generation component 420. The data retrieval component 410 is configured to receive the user input 401 and retrieve content items 403 related to the user input 401. In some implementations, the data retrieval component 410 may convert the user input 401 into one or more vector embeddings associated with a neural network model (such as the LLM 430) and search a vector repository 412 for one or more matching vector embeddings 402 based on a similarity score (such as cosine similarity). The data retrieval component 410 also retrieves one or more data chunks 403, from a data repository 414, associated with the matching vector embeddings 402.

In some implementations, the vector repository 412 and the data repository 414 may be examples of the output data repositories 107 of FIG. 1. More specifically, each vector embedding stored in the vector repository 412 (such as the embeddings 106 of FIG. 1) represents a respective chunk of data stored in the data repository 414 (such as the data segments 104 of FIG. 1). Thus, the content items 403 may include data chunks that can be mapped or otherwise correlated to the matching vector embeddings 402 (such as via a relational database). In some implementations, the data chunks may be partitioned along semantically related boundaries using an LLM (such as described with reference to FIGS. 1-3).

The prompt generation component 420 is configured to generate an LLM prompt 404 based on the user input 401 and the content items 403. In some implementations, the prompt generation component 420 may implement various prompt engineering techniques to query the LLM 430 for a response to the user input 401 based, at least in part, on the content items 403. For example, the LLM prompt 404 may include the user input 401 and the content items 403, as well as instructions to respond to the user input 401 using the provided content items 403 for context. The prompt generation component 420 emits the LLM prompt 404 to the LLM 430.

The LLM 430 infers or generates the completion 405 based on the LLM prompt 404. In some implementations, the LLM 430 may be stored and executed locally, for example, as an integrated component of the RAG system 400 (or the underlying computing platform or architecture). In some other implementations, the LLM 430 may be hosted remotely, for example, on a server or computing device that is separate from the RAG system 400. For example, the prompt generation component 420 may communicate with the LLM 430 via an application programming interface (API).

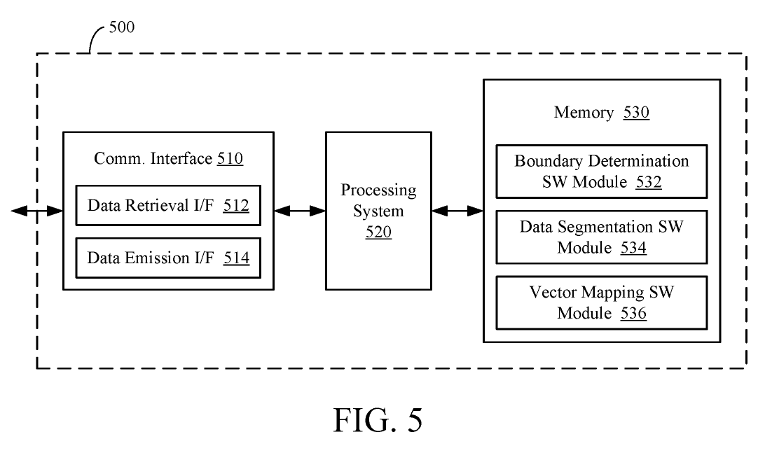

FIG. 5 shows another block diagram of an example data orchestration system 500, according to some implementations. In some implementations, the data orchestration system 500 may be one example of the data orchestration system 100 of FIG. 1 or the data processing pipeline 200 of FIG. 2. More specifically, the data orchestration system 500 is configured to convert a data asset into a set of vector embeddings.

The orchestration system 500 includes a communication interface 510, a processing system 520, and a memory 530. The communication interface 510 is configured to communicate with one or more data repositories. More specifically, the communication interface 510 includes a data retrieval interface (I/F) 512 for communicating with one or more input data repositories (such as the input data repositories 101 of FIG. 1) and a data emission interface (I/F) 514 for communicating with one or more output data repositories (such as the output data repositories 107 of FIG. 1).

The memory 530 includes a non-transitory computer-readable medium (including one or more nonvolatile memory elements, such as EPROM, EEPROM, Flash memory, or a hard drive, among other examples) that can store the following software (SW) modules: a boundary determination SW module 532 to determine one or more semantic boundaries associated with a data asset based on a neural network model; a data segmentation SW module 534 to segment the data asset into a plurality of chunks based at least in part on the one or more semantic boundaries; and a vector mapping SW module 536 to map the plurality of chunks to a plurality of vector embeddings, respectively, associated with the neural network model.

The processing system 520 includes any suitable one or more processors capable of executing scripts or instructions of one or more software programs stored in the data orchestration system 500 (such as in the memory 530). For example, the processing system 520 can execute the boundary determination SW module 532 to determine one or more semantic boundaries associated with a data asset based on a neural network model. The processing system 520 can execute the data segmentation SW module 534 to segment the data asset into a plurality of chunks based at least in part on the one or more semantic boundaries. The processing system 520 can further execute the vector mapping SW module 536 to map the plurality of chunks to a plurality of vector embeddings, respectively, associated with the neural network model.

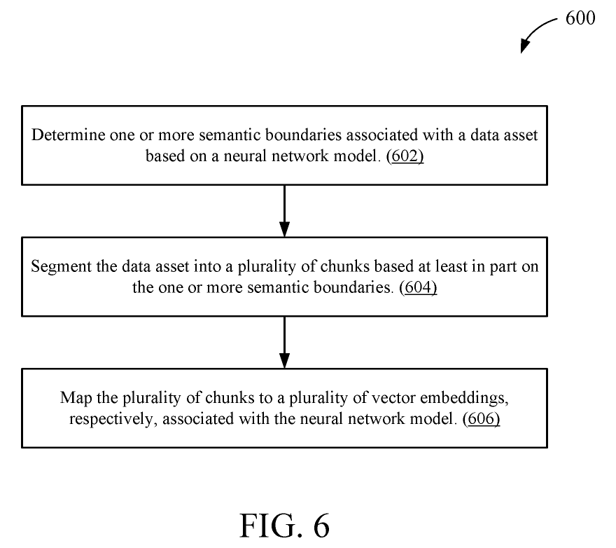

FIG. 6 shows an illustrative flowchart depicting an example operation 600 for generating embeddings, according to some implementations. In some implementations, the example operation 600 may be performed by a data orchestration system such as the data orchestration system 500 of FIG. 5.

The data orchestration system determines one or more semantic boundaries associated with a data asset based on a neural network model (602). In some implementations, the neural network model may be an LLM. The data orchestration system segments the data asset into a plurality of chunks based at least in part on the one or more semantic boundaries (604). The data orchestration system further maps the plurality of chunks to a plurality of vector embeddings, respectively, associated with the neural network model (606). In some implementations, the data orchestration system may further determine a size of each chunk of the plurality of chunks based on a dimension of each vector embedding of the plurality of vector embeddings and determine a number of chunks included in the plurality of chunks based on the size of each chunk.

In some aspects, the determining of the one or more semantic boundaries may include inferring a semantic cell from the data asset using the LLM and inferring a number (N) of learnings from the semantic cell using the LLM, where each of the N learnings is associated with a respective semantic boundary of the one or more semantic boundaries. In some implementations, the inferring of the semantic cell may include generating a prompt for the LLM requesting a group of semantically related content and receiving a completion from the LLM, responsive to the prompt, that includes the semantic cell. In some implementations, the inferring of the N learnings may include generating a prompt for the LLM requesting the number of learnings associated with the semantic cell and receiving a completion from the LLM, responsive to the prompt, that includes the N learnings. In some implementations, the prompt may further include a request to order the N learnings based on the order in which they are conveyed in the semantic cell.

In some aspects, the segmenting of the data asset may include segmenting the semantic cell into N chunks of the plurality of chunks based at least in part on the N learnings. In some implementations, the segmenting of the semantic cell may include inferring the N chunks from the semantic cell using the LLM so that each of the N chunks is associated with a respective learning of the N learnings. In some implementations, the inferring of the N chunks may include generating a prompt for the LLM requesting a partitioning of the semantic cell along boundaries associated with the N learnings and receiving a completion from the LLM, responsive to the prompt, that includes the N chunks.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method for generating embeddings, comprising:
determining one or more semantic boundaries associated with a data asset based on a neural network model;
segmenting the data asset into a plurality of chunks based at least in part on the one or more semantic boundaries; and
mapping the plurality of chunks to a plurality of vector embeddings, respectively, associated with the neural network model.

2. The method of claim 1, wherein the neural network model comprises a large language model (LLM).

3. The method of claim 2, wherein the determining of the one or more semantic boundaries comprises:
inferring a semantic cell from the data asset using the LLM; and
inferring a number (N) of learnings from the semantic cell using the LLM, each of the N learnings associated with a respective semantic boundary of the one or more semantic boundaries.

4. The method of claim 3, wherein the inferring of the semantic cell comprises:
generating a prompt for the LLM requesting a group of semantically related content; and
receiving a completion from the LLM, responsive to the prompt, that includes the semantic cell.

5. The method of claim 3, wherein the inferring of the N learnings comprises:
generating a prompt for the LLM requesting the number of learnings associated with the semantic cell; and
receiving a completion from the LLM, responsive to the prompt, that includes the N learnings.

6. The method of claim 5, wherein the prompt further includes a request to order the N learnings based on the order in which they are conveyed in the semantic cell.

7. The method of claim 3, wherein the segmenting of the data asset comprises:
segmenting the semantic cell into N chunks of the plurality of chunks based at least in part on the N learnings.

8. The method of claim 7, wherein the segmenting of the semantic cell comprises:
inferring the N chunks from the semantic cell using the LLM so that each of the N chunks is associated with a respective learning of the N learnings.

9. The method of claim 8, wherein the inferring of the N chunks comprises:
generating a prompt for the LLM requesting a partitioning of the semantic cell along boundaries associated with the N learnings; and
receiving a completion from the LLM, responsive to the prompt, that includes the N chunks.

10. The method of claim 1, further comprising:
determining a size of each chunk of the plurality of chunks based on a dimension of each vector embedding of the plurality of vector embeddings; and
determining a number of chunks included in the plurality of chunks based on the size of each chunk.

11. A data orchestration system comprising:
a processing system; and
a memory storing instructions that, when executed by the processing system, causes the data orchestration system to:
determine one or more semantic boundaries associated with a data asset based on a neural network model;
segment the data asset into a plurality of chunks based at least in part on the one or more semantic boundaries; and
map the plurality of chunks to a plurality of vector embeddings, respectively, associated with the neural network model.

12. The data orchestration system of claim 11, wherein the neural network model comprises a large language model (LLM).

13. The data orchestration system of claim 12, wherein the determining of the one or more semantic boundaries comprises:
inferring a semantic cell from the data asset using the LLM; and
inferring a number (N) of learnings from the semantic cell using the LLM, each of the N learnings associated with a respective semantic boundary of the one or more semantic boundaries.

14. The data orchestration system of claim 13, wherein the inferring of the semantic cell comprises:
generating a prompt for the LLM requesting a group of semantically related content; and
receiving a completion from the LLM, responsive to the prompt, that includes the semantic cell.

15. The data orchestration system of claim 13, wherein the inferring of the N learnings comprises:
generating a prompt for the LLM requesting the number of learnings associated with the semantic cell; and
receiving a completion from the LLM, responsive to the prompt, that includes the N learnings.

16. The data orchestration system of claim 15, wherein the prompt further includes a request to order the N learnings based on the order in which they are conveyed in the semantic cell.

17. The data orchestration system of claim 13, wherein the segmenting of the data asset comprises:
segmenting the semantic cell into N chunks of the plurality of chunks based at least in part on the N learnings.

18. The data orchestration system of claim 17, wherein the segmenting of the semantic cell comprises:
inferring the N chunks from the semantic cell using the LLM so that each of the N chunks is associated with a respective learning of the N learnings.

19. The data orchestration system of claim 18, wherein the inferring of the N chunks comprises:
generating a prompt for the LLM requesting a partitioning of the semantic cell along boundaries associated with the N learnings; and
receiving a completion from the LLM, responsive to the prompt, that includes the N chunks.

20. The data orchestration system of claim 11, wherein execution of the instructions further causes the data processing pipeline to:
determine a size of each chunk of the plurality of chunks based on a dimension of each vector embedding of the plurality of vector embeddings; and
determine a number of chunks included in the plurality of chunks based on the size of each chunk.
